(19) United States
(12) Patent Application Publication
(10) Pub. No.: US 2008/0001005 A1
(43) Pub. Date: Jan. 3, 2008

(54) Apparatus for evenly applying liquids to interior surfaces

(76) Inventors: Lance Weaver, Rapid City, SD (US); Bernt Askildsen, Rapid City, SD (US)

Correspondence Address: Gene R. Woodle, 3516 Woodle Drive, Rapid City, SD, 57702, US

(21) Appl. No.: 11/823,926

(22) Filed: Jun. 30, 2007

Related U.S. Application Data
(60) Provisional application No. 60/806,475, filed on Jul. 2, 2006.

(51) Int. Cl. B05B 3/00; E01H 3/02; B08B 3/12

(52) U.S. Cl. 239/225.1; 239/172; 239/263.1; 239/264; 134/172

(57) ABSTRACT

Embodiments of a apparatus for evenly applying liquids to interior surfaces are disclosed. The apparatus may be used to apply liquids or chemicals to the interior surfaces of a duct or conduit using a rotating sprayer. The speed of rotation of the sprayer may be adjusted such that the liquid or chemical is evenly applied to all interior surfaces of the duct regardless of the cross sectional shape of the duct.

### RELATED APPLICATIONS

This application relies for priority upon the Provisional Patent Application filed by Lance Weaver and Bernt Askildsen entitled Apparatus and method for evenly applying liquid substances internally in HVAC conduits and ducts, Ser. No. 60/806,475, filed Jul. 2, 2006.

### BACKGROUND OF THE INVENTION

1. Field of the Invention

The present invention relates generally to applying liquids to the interior surfaces of items such as ducts and more specifically to a apparatus for applying such liquids to such interior surfaces evenly where the cross section of such surfaces is not round.

2. Background Information

All around the United States and throughout the world, there are many miles of heating, ventilation, and air conditioning (HVAC) ducts. In order to insure efficient movement of air through such ducts and to prevent disease and the spread of irritating particles such as insulation fibers, it is necessary to maintain these HVAC ducts on a regular basis. Such maintenance often includes the spraying of various liquids onto the interior surfaces of such ducts. In some areas (including Title 24 of California's building code) efficient air flow through such ducts is mandated by law and HVAC ducts must be sealed to prevent air leakage. In many cases it is necessary to spray a liquid onto the inside surface of HVAC ducts to disinfect the ducts, to clean the ducts, or to seal the ducts to prevent the spread of fibers.

A number of inventions have been patented which attempt to deal with problems relating to coating the interior of an HVAC duct or similar article. The patent to Ryan (U.S. Pat. No. 3,800,358; Apr. 2, 1974) discloses a remote controlled self propelled duct cleaning robot for rectangular ducts and the patent to Creed (U.S. Pat. No. 4,141,753; Feb. 27, 1979) discloses a device for internal cleaning of a hollow, variable diameter, air and dirt evacuation duct which is coupled to a vacuum creating system. The patent to Weber et al. (U.S. Pat. No. 4,473,921; Oct. 2, 1984) discloses a cleaning device for the internal peripheral surfaces of pipelines of hollow cylindrical vessels. The patent to Weinstein et al. (U.S. Pat. No. 4,555,058; Nov. 26, 1985) discloses a coating applicator which uses a rotary atomizer on a driven shaft and the patent to Tachi et al. (U.S. Pat. No. 4,798,335; Jan. 1, 1989) discloses a rotating device for spraying coating which has a spaying head attached to a rotating shaft.

There are a number of problems relating to the application of coatings to the interior surface of articles such as HVAC ducts which still need to be addressed. Some devices have a rotating spray head which rotates through a 360 degree spray cycle and others have a fixed head which sprays in a conical pattern. These types of sprayers work fairly well when the duct has a round cross section, but work much less well when the cross section of the duct is square or rectangular. When a conventional rotating sprayer or a conical sprayer is used in a duct with a circular cross section, the liquid sprayed is distributed fairly evenly all around the interior circumference of the duct. However, when these types of sprayers are used in a duct with a square or rectangular cross section, they are much less efficient. Because the corners of such ducts are much further away from the spray head than the middle portions of a square duct less liquid is applied to the corners. This inefficiency is exacerbated when the cross section is rectangular, because not only are the corners further from the spray head than the middle portions, but either the top and bottom walls or the side walls are further than from the spray head than the other walls.

Because any liquid sprayed onto the interior walls of “irregularly” shaped ducts including square or rectangular cross sectional ducts, either the corners (or other surfaces further from the spray head) receive inadequate coverage or the other areas receive too much coverage. If the corners receive insufficient coverage, the function of the sprayed liquid is compromised. If the surfaces closer to the spray head receive too much liquid, the liquid is used inefficiently. Other problems may occur if excess liquid dribbles down the internal walls or puddles on the bottom wall of the duct.

The apparatus for evenly applying liquids to interior surfaces of the instant invention solves a number of problems relating to the spraying of a liquid onto the interior surfaces of a duct, conduit, or similar surface when the cross section of the duct is square, rectangular, or otherwise not round in a unique and original manner not exhibited in the prior art. The apparatus for evenly applying liquids to interior surfaces of the instant invention prevents provides for the even spray of liquids on such surfaces regardless of the cross sectional shape.

The ideal apparatus for evenly applying liquids to interior surfaces should have a rotating spray head which provides for the even spraying of the liquid. The ideal apparatus for evenly applying liquids to interior surfaces should provide a method for adjusting the flow rate of the spray such that the liquid is applied evenly to all interior surfaces even though some portions of these interior surfaces are further from the spray head than others. The ideal apparatus for evenly applying liquids to interior surfaces should also be simple, reliable, inexpensive, and easy to use.

### SUMMARY OF THE INVENTION

The apparatus for evenly applying liquids to interior surfaces of the instant invention includes a robot which may be operated remotely to travel through a HVAC duct or conduit or similar article. The robot has a boom attached with a pair of nozzles at the forward end. The boom along with the nozzles may be rotated at a variable rate. The robot is tethered and any of a variety of conventional duct or similar article treatment, cleaning, or maintenance liquids may be transmitted through the tether to the robot and sprayed from the two nozzles. In operation the robot moves rearward through the conduit and sprays liquid on the interior walls of the conduit.

The rotational speed of the boom and the nozzles may be controlled by a microprocessor. The rate of rotation may be adjusted to accomplish an even application of liquid by adjusting the rate of rotation of the boom. For example, if the cross section of the duct was square, the boom would rotate relatively quickly while liquid was being sprayed on the center portion of the walls of the duct and more slowly while liquid was being sprayed on the corners where the walls of the duct meet. Once the cross sectional configuration of the duct is known, the speed of rotation of the boom can be adjusted to insure that all interior surfaces of the duct are evenly sprayed with liquid. As will be understood, once the cross sectional configuration of any duct or similar article has been determined, interior coating of the duct may be evenly applied by adjusting the rate of rotation of the boom.

The above describes the basic configuration of the apparatus for evenly applying liquids to interior surfaces of the instant invention. Although the device is described as being used to apply liquid evenly to the interior surface of an HVAC duct or conduit, it will be understood that the device could also be to apply liquid sprays to any number of articles having a configuration similar to a duct or conduit.

One of the major objects of the present invention is to provide an apparatus for evenly applying liquids to interior surfaces which has a rotating spray head which provides for the even spraying of the liquid.

Another objective of the present invention to provide a method for adjusting the flow rate of the spray such that the liquid is applied evenly to all interior surfaces even though some portions of these interior surfaces are further from the spray head than others.

Another objective of the present invention is to provide a apparatus for evenly applying liquids to interior surfaces which is simple, reliable, inexpensive, and easy to use.

These and other features of the invention will become apparent when taken in consideration with the following detailed description and the drawings.

### BRIEF DESCRIPTION OF THE DRAWINGS

FIG. 1 is a side view of the apparatus for evenly applying liquids to interior surfaces of the instant invention inside a duct;

FIG. 2 is an isometric view of the spray boom of the apparatus for evenly applying liquids to interior surfaces of the instant invention;

FIG. 3 is an exploded isometric view of the spray boom of the apparatus for evenly applying liquids to interior surfaces of the instant invention; and

FIG. 4 shows a series of graphs of rotation speed versus time which shows the method of varying the speed of the spray boom of the apparatus for evenly applying liquids to the interior surfaces of the instant invention to provide an even coating regardless of the cross sectional shape of the duct.

### DESCRIPTION OF A PREFERRED EMBODIMENT

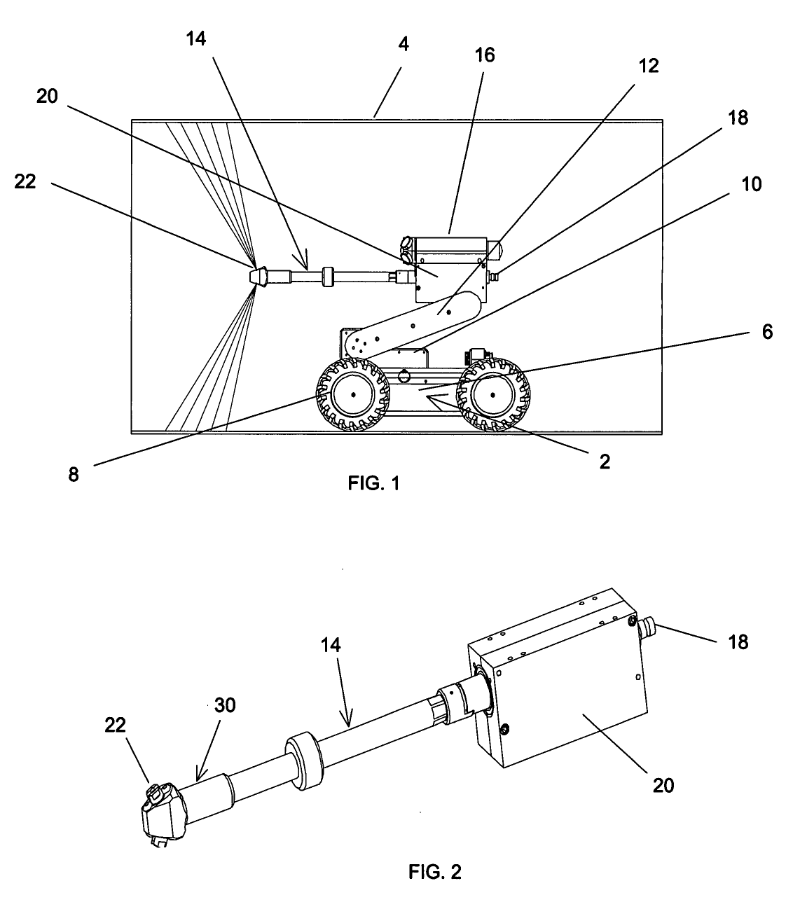

Referring to the drawings, FIGS. 1 through 3, there is shown a preferred embodiment of the apparatus for evenly applying liquids to interior surfaces of the instant invention. The instant invention is shown and described below as an apparatus for spraying a coating on the inside surfaces of an HVAC duct, but, without changing the spirit of the invention, the device could be used for a wide variety of other purposes.

Now referring to FIG. 1, a side view of the apparatus for evenly applying liquids to interior surfaces of the instant invention inside a duct is shown. In this view, left is considered forward and right is considered rearward. A robot 2 is provided which has the ability to be guided or programmed to move through the interior of a duct 4. The robot 2 includes a platform 6 which moves on four rotatable wheels 8. Two of the wheels 8 are powered by controllable electric motors (not shown). In the preferred embodiment, the left forward wheel 8 and the right rearward wheel 8 are powered. The electric motors are capable of being controlled to operate at variable speeds and in either direction either forward or in reverse. As the two powered wheels 8 can be rotated either forward or in reverse and at variable speed, said robot 2 may be moved in any direction and at a variety of speed through the duct 4. A housing 10 is affixed to the top of the platform 6 and a robotic arm 12 is rotatably affixed to the housing 10. There is an electric motor (not shown) within said housing 10 which is capable of being controlled and which may be used to rotate the robotic arm 12 where it is connected to said housing 10. A boom housing 20 is affixed to the end of said robotic arm 12 which is not connected to said housing 10. The boom housing 20 is adjustable such that said robotic arm 12 may be rotated and said boom housing 14 adjusted so that said boom housing 20 is horizontal and centered within said duct 4. A camera module 16 is affixed to the top of said boom housing 20. The camera module 16 has both forward and rearward facing cameras and light sources such that an operator at a remote location may see forward and rearward from said robot 2.

Still referring for FIG. 1, there is a spray boom 14 rotatably affixed within said boom housing 20. There is a snap attachment 18 at the rearward end of the spray boom 14. A chemical supply line (not shown) may be affixed to the snap attachment 18. There is a pair of nozzles 22 (better seen in FIG. 2) mounted to the forward end of said spray boom 14. The nozzles 22 are mounted at substantially 180 degrees from each other and substantially perpendicular to said spray boom 14. Any of a variety of chemicals which are desired to be sprayed are introduced under pressure into said spray boom 14 through said snap attachment 18. The chemicals are sprayed through said nozzles 22 in a pattern which is slightly forward from vertical and applied to the walls of said duct 4. Because said spray boom 14 rotates, the chemical is applied to all interior surfaces of said duct 4. In operation, said robot 2 moves rearward through said duct 4 such that said wheels 8 do not contact the sprayed chemical.

Still referring to FIG. 1, there is a sliding mass 16 which is slidably affixed within said slot 14. The sliding mass 16 is comprised of a top mass 18 and a bottom mass 20. A pair of top mass pins 22 protrude downward from the longitudinal axis of the top mass 18 and slide within said slot 14. The top mass pins 22 engage a pair of complimentary centering holes 24 (see FIG. 2) in the bottom mass 20. There is a recess 26 in the bottom surface of said top mass 18. A spring 28 and a stop 30 fit within the recess 26. A bolt 32 fits through a bolt hole 34 through the center of said top mass 18 and engages a threaded hole 36 in the center of said bottom mass 20. When the bolt 32 is tightened, said top mass 18 is secured to said bottom mass 20 and said sliding mass 16 may slide freely within said slot 14. The spring 28 tends to press the stop 30 against the top surface of said main bar 2, which tends to prevent said sliding mass 16 from moving until force is applied to it.

Referring now to FIG. 2, an isometric view of the spray boom of the apparatus for evenly applying liquids to interior surfaces of the instant invention is shown. This view better shows said nozzles 22 as they are affixed to a spray head 30. The spray head 30 makes up the forward end of said spray boom 14. The rearward end of said spray boom 14 is rotatably affixed within said boom housing 20 such that it rotates freely within said boom housing 20, but is not free to move forward or rearward within said boom housing 20. Said snap attachment 18 is affixed to the rearward end of said spray boom 14 and rotates with it.

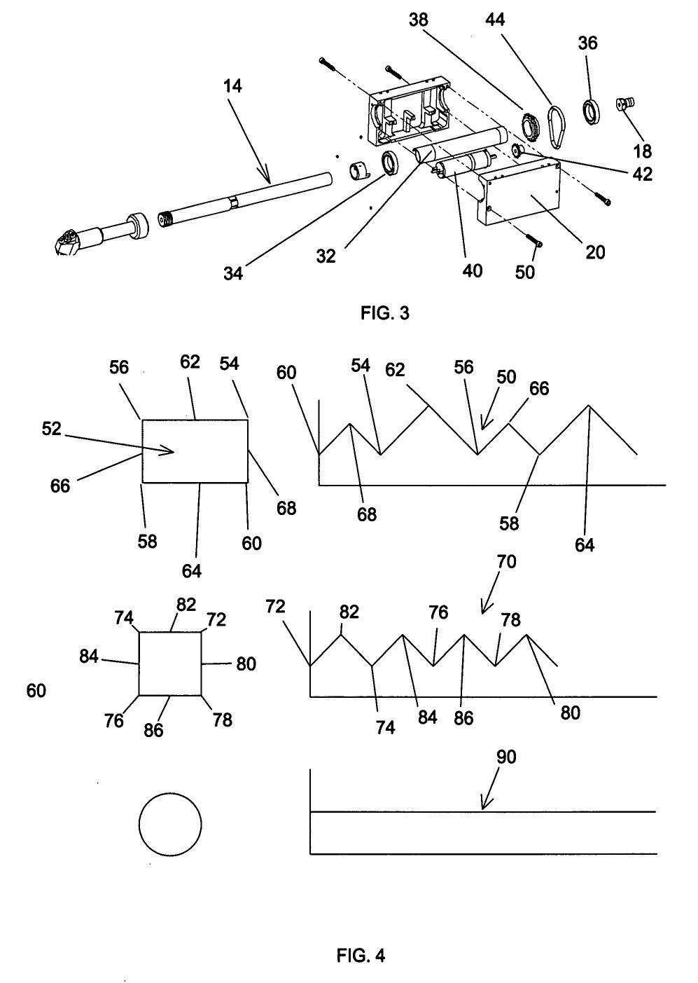

Referring now to FIG. 3, an exploded isometric view of the spray boom of the apparatus for evenly applying liquids to interior surfaces of the instant invention is shown. Said boom housing 20 comes in two parts with apertures in either end which accommodate a spray boom sleeve 32 which fits and rotates within the apertures in said boom housing 20. The boom sleeve 32 is a part of said spray boom 14 and is held in place within said boom housing 20 by a front bearing 34 at the forward aperture in said boom housing 20 and by a rear bearing 36 at the rearward aperture in said boom housing 20. A boom gear 38 is affixed to said boom sleeve 32 near the rearward end of said boom sleeve 32 within said boom housing 20. A boom motor 40 is also affixed within said boom housing 20 and has a motor gear 42 at its rearward end. A boom chain 44 engages both said motor gear 42 and said boom gear 38 such that when said motor gear 42 turns, said boom gear 38 also turns. Four screws 50 are used to fasten the two sides of said boom housing 20 together. As the rotational speed of said boom motor 40 is fully controllable, the rotational speed of said spray boom 14 is also fully controllable.

Referring now to FIG. 4, a series of graphs of rotation speed versus time which shows the method of varying the speed of the spray boom of the apparatus for evenly applying liquids to the interior surfaces of the instant invention to provide an even coating regardless of the cross sectional shape of the duct is shown. As described above said robot 2 may be moved through a duct and any of various chemicals or liquids sprayed on the interiors surfaces of a duct using said spray boom 14. The chemical is applied by forcing the chemical through said nozzles 22. Said spray boom 14 is rotated such that the spray is applied to all interior surfaces of the duct. The speed of rotation of said spray boom 14 is fully controllable. Thus, the speed of rotation may be controlled to insure even distribution of chemicals to all interior surfaces of the duct by controlling the rotation speed. The method of varying speeds to accommodate ducts of various cross sections is illustrated by the graphs in FIG. 4.

Still referring to FIG. 4, graph 50 shows the rotation speed versus time for a duct having a cross sectional area 52. The spinning nozzles 22 are located at the center of the duct. In general, the rotation speed is faster when the side walls of the duct are closest to said nozzles 22 and slower when the side walls of the duct are farther from said nozzles 22. This provides for even distribution of chemicals to all interior surfaces of the duct. As may be seen, the rotational speed is slowest at points 54, 56, 58, and 60 and fastest at points 62 and 64. The rotational speed at points 66 and 68 is at an intermediate speed between the slowest and the fastest. The graph 70 shows rotational speed versus time for a duct having a square cross section 100. As may be seen, the rotational speed is slowest at the corners of the duct 72, 74, 76, and 78, and fastest at the central portions of the walls of the duct 80, 82, 84, and 86. Graph 90 shows rotational speed versus time for a duct having a circular cross section. In this instance, since all the walls are equidistant from said nozzles 22, the rotational speed does not vary.

There is a tether (not shown) affixed to said robot 2 and video feedback and motors are controlled through this tether. A conventional microprocessor is used to control the motors The rotational speed of said spray boom 14 may be preprogrammed into the microprocessor to accommodate the cross sectional shape of the duct. Movement of said robot 2 through the duct may be either programmed into the microprocessor or remotely controlled by an operator using said camera module 16.

All elements of the apparatus for evenly applying liquids to interior surfaces are made of stainless steel except for those described below, but other material having similar strength and stiffness could be used. The wheels, gears, motors, screws, and nozzles are conventional and may be easily obtained from a variety of sources.

While preferred embodiments of this invention have been shown and described above, it will be apparent to those skilled in the art that various modifications may be made in these embodiments without departing from the spirit of the present invention.

We claim:

1. An apparatus for evenly applying liquids to interior surfaces of a defined enclosed space where the defined enclosed space has interior walls and a consistent cross sectional shape along its length and a forward end and a rearward end comprising:
(1) rotating sprayer capable of spraying liquids in at least one direction toward the interior walls of the defined enclosed space, the rotating sprayer also being capable of being positioned near a longitudinal axis through the center of the defined enclosed space and capable of being rotated a various speeds such that, when rotating, said rotating sprayer sprays liquid onto all of the interior walls of the defined enclosed space; and
(2) a control system capable of controlling the rotational speed of said rotating sprayer such that when areas of the defined enclosed space further from said rotating sprayer are being sprayed, the rotational speed of said rotating sprayer may be decreased and when areas of the defined enclosed space closer to said rotating sprayer are being sprayed, the rotational speed of said rotating sprayer may be increased;
whereby the apparatus for evenly applying liquids to interior surfaces may be used to spray liquid onto the interior walls of the defined enclosed space evenly by reducing the rotation speed of said rotating sprayer when spraying areas further from said rotating sprayer and increasing the rotation speed of said rotating sprayer when spraying areas closer to said rotating sprayer.

2. The apparatus of claim 1 in which the control system is further capable of controlling the movement of said rotating sprayer through the defined enclosed space such that said rotating sprayer may be moved either forward or rearward through the defined enclosed space at a set speed and along a set path.

3. The apparatus of claim 1 in which an operator remotely controls the movement of said rotating sprayer through the defined enclosed space.
